(19) United States
(12) Patent Application Publication
(10) Pub. No.: US 2011/0170981 A1
(43) Pub. Date: Jul. 14, 2011

(54) WALL FASTENING ASSEMBLY

(76) Inventor: Peter Gold, Rockville Centre, NY (US)

(21) Appl. No.: 12/685,070

(22) Filed: Jan. 11, 2010

(51) Int. Cl. F16B 33/00; B23P 11/00

(52) U.S. Cl. 411/345; 29/525.01

(57) ABSTRACT

A fastening assembly for retaining an object to a wall having a hole extending therethrough, including an elongated flexible planar retaining strap and a elongated rigid anchoring member which is mounted adjacent to the distal end of the retaining strap so it normal assumes a position generally perpendicular to the retaining strap. The retaining strap is flexible and can be manipulated and bent relative to the anchoring member to permit the anchoring member and retaining strap to be inserted through the hole in the wall and pulled against the back of the wall. The object to held is preferably locked onto the retaining strap on the first side of the wall, by a second anchoring member in order to retain the object against the wall.

### BACKGROUND OF THE INVENTION

1. Field of the Invention

The invention is generally in the field of fastening devices. More particularly, the present invention is an improved versatile wall fastening assembly which is particularly useful with a hollow wall where one side of the wall is concealed.

2. Brief Description of the Prior Art

Presently, there are known numerous anchoring or fastening devices for use in retaining or mounting an object on a wall, ceiling or the like. Furthermore, there are many anchoring or fastening assemblies which are particularly useful and designed to retain an object on a wall wherein one of the sides of the wall is concealed and, therefore, inaccessible. Similar devices are also utilized for other purposes such as assembling furniture, fastening appliance components together or fastening signs, etc. As a result, various types of bolts, screws, nails and other fastening devices for this purpose are known. Consequently, the field of fastening or anchoring devices, especially for retaining an object on a hollow or relatively thin wall is replete with numerous well known devices and fastening aids which seek to fasten or support an object to a wall.

While these fastening devices can be satisfactorily utilized, they have some disadvantages. Particularly, many such devices are limited in their particular application and can only be used to fasten an object to a wall. These wall fastening devices can also be cumbersome, expensive and can be difficult to install. Furthermore, many such devices are incapable of anchoring fairly heavy objects to a wall or ceiling where no stud or other wood bearing member is present. Therefore, certain anchoring or fastening devices can loosen over time if not firmly embedded in the stud of the wall. Furthermore, many of these devices are often a complex structure and cannot be used for a wide range of fastening applications.

Therefore, it is advantageous to have a fastening assembly which is relatively simple, easy to manufacture, and which can be applied to a variety of articles including a hollow wall in which one side is concealed. It is also advantageous to have a versatile fastening assembly and one which is quick and easy to use and install.

The prior art discloses many different types of fastening devices or assemblies for mounting objects on a wall and for use in other devices. However, so far as is known, none of the prior art devices resolve all of these problems in a simple, effective and yet highly advantageous manner as does the present invention discussed herein.

### SUMMARY OF THE INVENTION

It is therefore an object of the invention to provide a novel fastening assembly for retaining an object to a wall having a first and second side and a hole extending therethrough.

It is also an object of the invention to provide a fastening assembly which can secure an object to a wall having a concealed side.

It is another object of the invention to provide a fastening assembly which is versatile and can be used to fasten various items together.

It is yet another object of the invention to provide a fastening assembly which has a relatively simply construction.

It is a further object of the invention to provide a fastening assembly which is quick and easy to use and install.

It is another object of the invention to provide a fastening assembly which is versatile and can be used in various manners to retain objects.

It is yet another object of the invention to provide a fastening assembly which is simple, easy and inexpensive to manufacture.

Certain of the foregoing and related objects are readily attained according to the present invention by the provision of a fastening assembly for retaining an object to a wall having a first and second side, and a hole extending therethrough. The assembly comprises an elongated, flexible planar retaining strap having a distal end configured and dimensioned for insertion into and through the hole in the wall, a proximal end opposite therefrom, and a length which is greater than the thickness of the wall. The assembly also comprises a first elongated, rigid anchoring member having two opposite ends, each of which is configured and dimensioned for insertion into and through the hole in the wall, and having a length which is greater than the diameter of the hole in the wall and which is mounted adjacent said distal end of said retaining strap so it normally assumes a position generally perpendicular to said planar retaining strap. The anchoring member has a width which permits it to be initially inserted via one of its said ends into and through the hole in the wall from the first side of the wall to the second side of the wall. The flexible retaining strap can be manipulated and bent relative to said anchoring member to permit said distal end of said retaining strap and said anchoring member to be inserted from the first side of the wall through the hole in the wall, to the second side of the wall and wherein when said anchoring member, upon being fully inserted through the hole in the wall, assumes its normal generally perpendicular orientation relative to said retaining strap on the second side of the wall. The assembly further comprises means for locking said retaining strap and, in turn, said assembly to the wall, which is located on the first side of the wall so that the object to be retained is fastened to the wall.

Preferably, the retaining strap has at least one hole formed therethrough and said anchoring member is retained in said at least one hole. It is also preferred that the retaining strap has a plurality of spaced apart holes formed therethrough and/or has graduations imprinted thereon. It is further preferred that the retaining strap has a plurality of ratchet-like ridges formed therein.

Advantageously, the anchoring member is a nail. Furthermore, it is preferable that the retaining strap is made of a resilient material which has a spring memory such that said retaining strap is effectively biased to assume said insertion position but resumes said normal unbiased position when said anchoring member is on the second side of the wall.

In a further preferred embodiment, the anchoring member is retained in said at least one hole of said retaining strap by a friction fit. Advantageously, the anchoring member has a width which is smaller than the diameter of the hole in the wall.

In yet another preferred embodiment, the means for locking said retaining strap comprises a one-way slidable locking member which is configured and dimensioned to permit it to be slidably received over said proximal end of said retaining strap and advanced towards the distal end of said retaining strap and which has a pawl to lock onto said ridges of said retaining strap to prevent said locking member from sliding towards said proximal end of said retaining strap.

In a further preferred embodiment, said means for locking said retaining strap comprises an externally threaded rod having a hook-shaped distal end which is configured and dimensioned to permit it to be inserted into and through the hole in the wall from the first side to the second side of the wall and hook around said anchoring member on the second side of the wall, and a proximal end opposite therefrom; and an internally threaded nut configured and dimensioned to be screwed onto said proximal end of said externally threaded rod.

In another preferred embodiment, said means for locking said retaining strap comprises a second elongated rigid anchoring member which has a length which is greater than the diameter of the hole in the wall and is configured and dimensioned to be retained in a hole of said retaining strap on the first side of the wall by a friction fit. Advantageously, said second anchoring member has two opposite ends and a bend formed between said ends.

In yet another preferred embodiment, said means for locking said retaining strap comprises a hollow, externally threaded cylindrical retaining member having a proximal end and a distal end and two opposite cut out portions on said distal end, which are configured and dimensioned to receive said anchoring member therein; and an internally threaded nut which is configured and dimensioned to be screwed onto said externally threaded cylindrical retaining member.

Most desirably, said retaining strap has a width which is slightly less than the diameter of the hole in the wall.

Certain of the forgoing and related objects are also readily attained according to the present invention by the provision of a method of fastening an object to a wall having a first and second side and a hole extending therethrough, comprising the steps of a) providing a wall fastening assembly comprising an elongated, flexible planar retaining strap having a distal end configured and dimensioned for insertion into and through the hole in the wall, a proximal end opposite therefrom, and a length which is greater than the thickness of the wall; a first elongated, rigid anchoring member having two opposite ends, each of which is configured and dimensioned for insertion into and through the hole in the wall, and having a length which is greater than the diameter of the hole in the wall and which is mounted adjacent said distal end of said retaining strap so it normally assumes a position generally perpendicular to said planar retaining strap, and wherein said anchoring member has a width which permits it to be initially inserted via one of its said ends into and through the hole in the wall from the first side of the wall to the second side of the wall and wherein said flexible retaining strap can be manipulated and bent relative to said anchoring member to permit said distal end of said retaining strap and said anchoring member to be inserted from the first side of the wall through the hole in the wall, to the second side of the wall and wherein when said anchoring member, upon being fully inserted through the hole in the wall, assumes its normal generally perpendicular orientation relative to said retaining strap on the second side of the wall; and means for locking said retaining strap and, in turn, said assembly to the wall, which is located on the first side of the wall so that the object to be retained is fastened to the wall; b) bending said retaining strap from said normal position to said insertion position; c) inserting said distal end of said retaining strap and said anchoring member from the first side of the wall through the hole in the wall to the second side of the wall, so that said anchoring member is fully inserted through the hole in the wall to permit said assembly to return to its normal position on the second side of the wall, while holding said proximal end of said retaining strap; d) pulling said proximal end of said retaining strap so that said anchoring member is positioned against the second side of the wall; and e) fastening the object to be retained onto said retaining strap by the means for locking.

In a preferred embodiment, step e) comprises the steps of: placing the object to be retained over said proximal end of said retaining strap; providing a second anchoring member which has a length which is greater than the diameter of the hole in the wall and is configured and dimensioned to te retained in a hole of said retaining strap on the first side of the wall by a friction fit; inserting said second anchoring member into said aligned holes adjacent to the wall.

In another preferred embodiment, step e) comprises the steps of: placing the object to be retained over said proximal end of said retaining strap; forming a loop in said retaining strap by bending said proximal end of said retaining strap over itself towards the wall; aligning two of said plurality of holes on said retaining strap adjacent to the opening in the wall; providing a second anchoring member which has a length which is greater than the diameter of the hole in the wall and is configured and dimensioned to be retained in a hole of said retaining strap on the first side of the wall by a friction fit; inserting said second anchoring member into said aligned holes adjacent to the wall.

In yet another preferred embodiment, step e) comprises the steps of forming a loop in said retaining strap by bending said proximal end of said retaining strap over itself towards the wall; aligning two of said plurality of holes on said retaining strap adjacent to the opening in the wall; providing a second anchoring member which has a length which is greater than the diameter of the hole in the wall and is configured and dimensioned to be retained in a hole of said retaining strap on the first side of the wall by a friction fit; inserting said second anchoring member into said aligned holes adjacent to the wall; and fastening the object to be retained onto said loop.

Furthermore, in another preferred embodiment, step e) comprises the steps of providing a second elongated rigid anchoring member which has a length which is greater than the diameter of the hole in the wall and is configured and dimensioned to be retained in a hole of said retaining strap on the first side of the wall by a friction fit and having two opposite ends and a bend formed between said ends inserting said second anchoring member into one of said plurality of holes of said retaining strap adjacent to the opening in the wall; and fastening the object to be retained onto said bend of said second anchoring member.

In yet another preferred embodiment, step e) comprises the steps of providing an externally threaded rod having a hook-shaped distal end which is configured and dimensioned to permit it to be inserted into and through the hole in the wall from the first side to the second side of the wall and hook around said anchoring member and a proximal end opposite therefrom and an internally threaded nut configured and dimensioned to be screwed onto said proximal end of said externally threaded rod; inserting said hook-shaped distal end of said externally threaded rod from the first side of the wall through the hole in the wall and to the second side of the wall; hooking said hook-shaped distal end of said externally threaded rod around said anchoring member on the second side of the wall; placing the object to be retained over said proximal end of said externally threaded rod; and screwing said internally threaded nut over said proximal end of said externally threaded rod.

Additionally, in another embodiment, step e) comprises the steps of providing a hollow, externally threaded cylindrical retaining member having a proximal end and a distal end and two opposite cut out portions on said distal end, which are configured and dimensioned to receive said anchoring member therein and an internally threaded nut which is configured and dimensioned to be screwed into said proximal end of said externally threaded cylindrical retaining member; inserting said distal end of said externally threaded cylindrical retaining member from the first side of the wall through the hole in the wall and to the second side of the wall; aligning the cut out portions on said distal end of said externally threaded cylindrical retaining member with said anchoring member on the second side of the wall such that said retaining member is received within said cut out portions of said cylindrical retaining member; placing the object to be retained over said proximal end of said externally threaded cylindrical retaining member; screwing said internally threaded nut over said externally threaded cylindrical retaining member.

In yet another preferred embodiment, step a) said elongated, flexible planar retaining strap has a plurality of ratchet-like ridges formed therein and in said step e) said locking means is a one-way slidable locking member which is configured and dimensioned to permit it to be slidably received over said proximal end of said retaining strap and advanced towards the distal end of said retaining strap and which has a pawl to lock onto said ridges of said retaining strap to prevent said locking member from sliding towards said proximal end of said retaining strap and, in turn, locks said assembly to the wall on the first side of the wall so that the object to be retained is fastened to the wall and a hollow, externally threaded cylindrical retaining member having a proximal end and a distal end and two opposite cut out portions on said distal end, which are configured and dimensioned to receive said anchoring member therein; and wherein step e) comprises the steps of inserting said distal end of said externally threaded cylindrical retaining member from the first side of the wall through the hole in the wall and to the second side of the wall aligning the cut out portions on said distal end of said externally threaded cylindrical retaining member with said anchoring member on the second side of the wall such that said retaining member is received within said cut out portions of said cylindrical retaining member; placing the object to be retained over said proximal end of said externally threaded cylindrical retaining member; and sliding said locking member over said proximal end of said retaining strap so that said pawl locks onto said ridges of said retaining strap adjacent to the proximal end of said cylindrical retaining member.

Other objects and features of the present invention will become apparent from the detailed description considered in connection with the accompanying drawings, which disclose several embodiments of the invention. It is to be understood that the drawings are to be used for the purpose of illustration only and not as a definition of the limits of the invention.

### BRIEF DESCRIPTION OF THE DRAWINGS

FIG. 1 is a perspective view of the retaining strap and anchoring member of a wall fastening assembly according to the invention;

FIG. 2a is a side elevational view of the anchoring member and the retaining strap being bent and inserted into a hole in the wall shown in cross-section;

FIG. 2b is a side elevational view comparable to FIG. 2a, but showing the retaining strap and the anchoring member returned to their normal positions relative to one another once the anchoring member is fully inserted through the hole onto the second side of the wall;

FIG. 2c is a perspective view of the retaining strap and the anchoring member in their final intended positions on the second side of the wall;

FIG. 2d is a side elevational view comparable to FIGS. 2a and 2b, but showing the object to be mounted on the wall placed on the retaining strap on the first side of the wall;

FIG. 2e is a side elevational view comparable to FIG. 2d, but showing a first embodiment of the locking means for the fastening assembly where a second anchoring member is inserted into a hole of the retaining strap;

FIG. 3a is a side elevational view comparable to FIG. 2d, but showing the retaining strap being bent to form a loop and to align two holes of the retaining strap adjacent the first side of the wall;

FIG. 3b is a side elevational view comparable to FIG. 3a, but showing a second anchoring member being inserted into the holes aligned in FIG. 3a;

FIG. 3c is a perspective view of the wall fastening assembly shown in FIG. 3b in its final intended position viewed from the first side of the wall;

FIG. 4a is a side elevational view showing a second embodiment of the locking means in which a bent nail is initially positioned to be inserted into a hole in the retaining strap;

FIG. 4b is a side elevational view comparable to FIG. 4a, but showing the bent nail of the fastening assembly in its final intended position;

FIG. 4c is a perspective view of FIG. 4b fastening assembly in its final mounted position as seen from the first side of the wall;

FIG. 5a is a side elevational view of a third embodiment of the locking means in which an externally threaded hook-shaped rod is shown being inserted through the hole in the wall;

FIG. 5b is a side elevational view comparable to FIG. 5a, showing the externally threaded hook-shaped rod fully inserted and being hooked around the anchoring member;

FIG. 5c is a side elevational view comparable to FIG. 5b, also showing a washer, an object to be mounted on the wall and a nut secured onto the wall fastening assembly in its final intended position;

FIG. 5d is a perspective view showing the externally threaded hook-shaped rod hooked around the anchoring member as viewed from the second side of the wall;

FIG. 5e is a perspective view comparable to that of FIG. 5d but viewed from the first side of the wall;

FIG. 6a is an exploded view of the components of a fourth embodiment of the locking means for the wall fastening assembly;

FIG. 6b is a side elevational view of the fourth embodiment of the locking means of the fastening assembly in which an externally threaded cylindrical retaining member and the object to be mounted are placed over the retaining strap;

FIG. 6c is a side elevational view comparable to FIG. 6b, further showing the locking means placed over the retaining strap and the wall fastening assembly in its final intended position.

FIG. 6d is an enlarged fragmentarily illustrated perspective view of the retaining strap and locking means shown in FIG. 6c, with the locking means shown in cross-section;

FIG. 7 is a side elevational view of the fifth embodiment of the locking means and the wall fastening assembly in its final intended position.

### DETAILED DESCRIPTION OF THE PREFERRED EMBODIMENTS

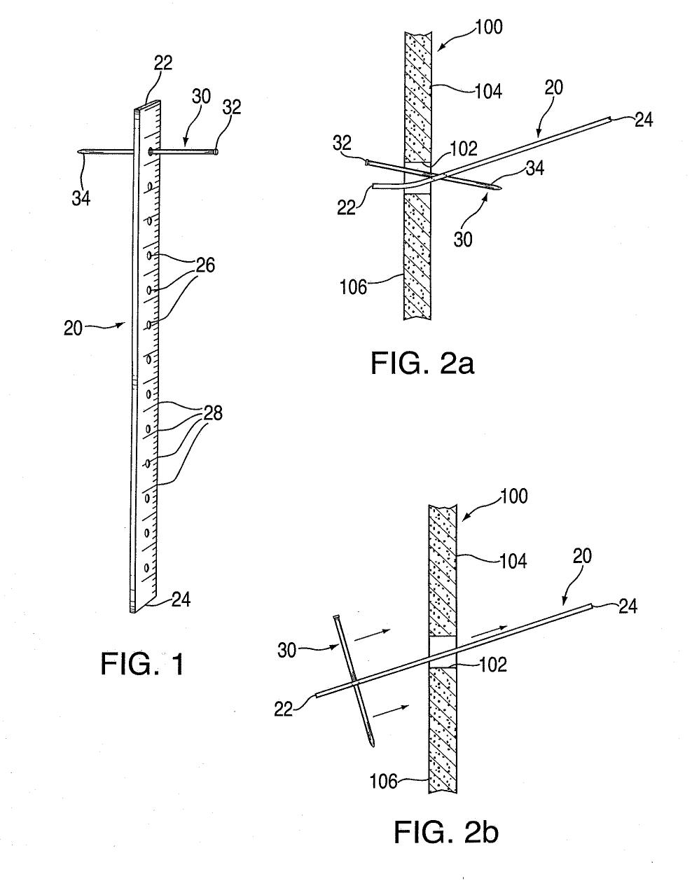

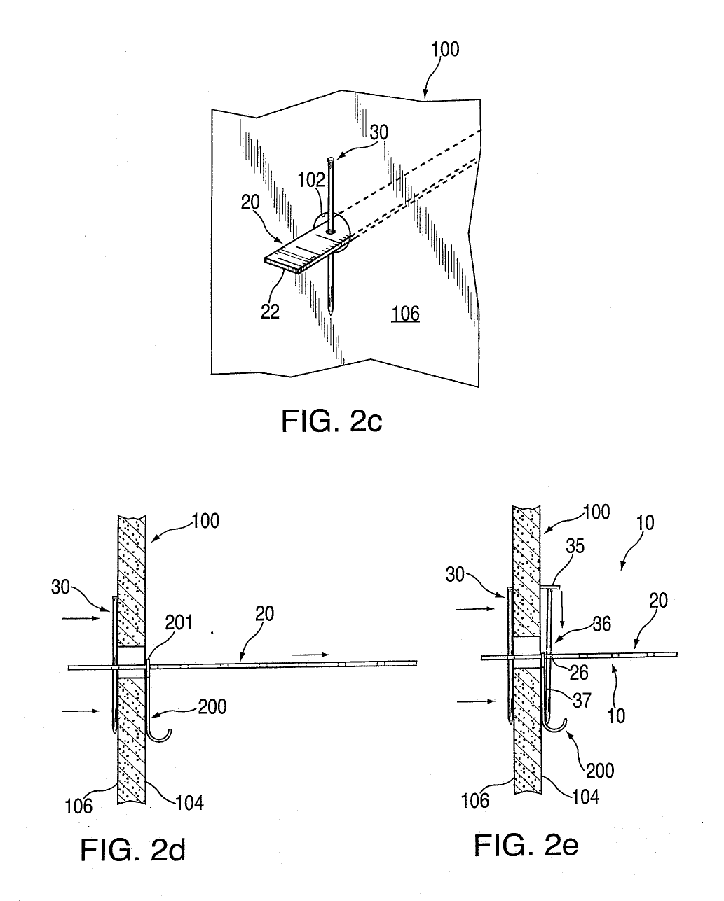

Turning now in detail to the drawings and in particular, FIGS. 1 and 2a-2e thereof, therein illustrated is a novel wall fastening assembly embodying the present invention, generally designated by reference numeral 10, for mounting an object on a wall 100 (FIG. 2a) having a first side 104, a second side 106 and a hole 102 extending therethrough. Advantageously, the assembly can be utilized when one of the sides of the wall 100 is concealed, unexposed or inaccessible. However, the fastening assembly is versatile and can, as well, be utilized to retain or mount an object on a wall where both sides of the wall are exposed. Furthermore, the fastening assembly can be used to fasten objects not only to walls but to ceilings, floors or virtually limitless other applications such as, fastening road signs, fastening objects to a boat, fastening objects to a deck, fastening parts of products together, etc.

As seen best in FIG. 1, the wall fastening assembly 10 comprises an elongated, flexible planar retaining strap, generally designated by reference numeral 20, which has a distal end 22 and a proximal end 24 opposite therefrom. As seen in FIG. 2a, the distal end 22 of the retaining strap 20 is configured and dimensioned for insertion into and through the hole 102 in the wall 100, from the first side of the wall 104 to the second side of the wall 106. In particular, the distal end 22 of the retaining strap 20 can be dimensioned to have a width which is smaller than the diameter of the hole 102. Alternatively, the retaining strap 20 can be made of a material which is flexible yet resilient, such as certain plastics, so that the distal end 22 can be bent to fit through the hole 102. However, the width of the retaining strap 20 can vary depending on the circumstances, such as the size of the object to be retained or the size of the hole in the wall. It is advantageous that the width of the retaining strap 20 be slightly less than the diameter of the hole 102, so that the retaining strap is centrally located in the hole 102 and is prevented from moving within the hole.

The retaining strap 20 also has a length which is greater than the thickness or depth of the wall 100, so that the proximal end 24 remains on the first side of the wall 104, when the distal end 22 is inserted through the hole 102, to the second side of the wall 106 (FIG. 2g). As shown in FIG. 2c, the retaining strap 20 also has a width which permits the distal end 22 to be inserted into and through the hole 102. Advantageously, as seen best in FIG. 1, the retaining strap 20 also has graduations 28 imprinted thereon to serve as a measuring device, for example, to measure the thickness or depth of the wall. The length of the retaining strap 20 can also vary depending on the size of the object to be retained.

As also seen in FIG. 1, the assembly 10 comprises a first elongated, rigid anchoring member, in this embodiment, a metal nail, generally designated by reference numeral 30, to serve as the “back” support, on the second side of the wall 106 for the object to be retained. As shown in FIG. 2a, the nail 30 has two opposite ends 32 and 34, each of which is configured and dimensioned to permit the nail 30 to be inserted into and through the hole 102 in the wall 100, from the first side of the wall 104 to the second side of the wall 106. As seen best in FIG. 2c, the nail 30 also has a length which is greater than the diameter of the hole 102 so that the nail 30 spans the diameter of the hole 102, and overlies and abuts the second side of the wall 106 on either or both sides of the hole 102, to prevent the nail 30 from passing back through the hole 102 to the first side of the wall 104, once inserted. The length of the anchoring member 30 can vary depending on the desired size of the hole and the weight of the object to be retained.

The anchoring member 30 also has a width which permits it to be initially inserted via one of its ends 32 or 34 into and through the hole 102 in the wall 100 (FIG. 2a). While the anchoring member 30 is preferably a metal nail, it can be a plate or rod and made of other rigid materials such as plastic.

As best seen in FIG. 1, the anchoring member 30 is mounted adjacent to said distal end 22 of the retaining strap 20, so it normally assumes a position generally perpendicular to the planar retaining strap 20. Preferably, the retaining strap 20 has a plurality of spaced apart holes 26 formed therethrough and the anchoring member 30 is retained in one of the holes 26 in the retaining strap 20. It can be appreciated that the anchoring member can be held in any hole 26 and therefore, at any desired position on the retaining strap 20, depending on the circumstances. The ends 32 and 34 of the anchoring member 30 can be equally spaced from the retaining strap 20 so that the retaining strap 20 is centered on the anchoring member 30 as seen in FIG. 1. Alternatively, one of the ends 32 or 34 can be located closer to the retaining strap 20, so the retaining strap is not centered on the anchoring member. The off-centered position is advantageous so that the anchoring member 30 avoids obstructions on the second side of the wall 106, such as electrical boxes, ceilings, floors, studs, etc. (not shown).

Advantageously, anchoring member 30 is retained in one of the holes 26 of the retaining strap 20 by a friction fit. However, the anchoring member 30 can also be retained in one of the holes 26 of the retaining strap 20 with the use of a glue or an adhesive. Alternatively, the retaining strap 20 and the anchoring member 30 can be an integral one-piece resilient plastic or metal component.

Turning now to FIG. 2a, the retaining strap 20 is flexible to permit it to be manipulated and bent by manual or hand manipulation relative to the anchoring member 30, to bias it from its normal position shown in FIG. 1 to its bent or insertion position shown in FIG. 2a. When in the insertion position, the retaining strap 20 is bent or biased to a sufficient degree towards the anchoring member 30, to occupy a space smaller than the diameter of the hole 102 in the wall and to permit the distal end 22 of the retaining strap 20 and the anchoring member 30 to be inserted from the first side of the wall 104 through the hole 102 in the wall 100, to the second side of the wall 106 (FIGS. 2a and 2b).

The insertion position permits the distal end 22 of the retaining strap 20, and one of the ends 32 or 34 of the anchoring member 30 to be inserted through the hole 102 in the wall 100. As shown in FIG. 2a, the retaining strap 20 and the anchoring member 30 are inserted into the hole 102 in the wall from the first side of the wall 104 to the second side of the wall 106, until the entire anchoring member 30 is fully inserted through the hole 102 in the wall 100 (FIG. 2b). While inserting the retaining strap 20 and anchoring member 30 through the hole 102, the user holds onto the proximal end 24 of the retaining strap 20 (not shown) to prevent the entire retaining strap 20 from being inserted through the hole 102 in the wall 100. Thus, the retaining strap 30 has a length which is long enough to permit the anchoring member 30 to pass entirely through the hole 102 while the user holds onto the proximal end 24 of the retaining strap 20.

As shown in FIG. 2b, once the entire anchoring member 30 is fully inserted through the hole 102 to the second side of the wall 106, the proximal end 24 of the retaining strap 20 remains on first side of the wall 104. Once the anchoring member 30 is fully inserted through the hole 102 to the second side of the wall 106, the anchoring member 30 and retaining strap 20 resume their normal positions shown in FIG. 1, wherein the anchoring member 30 is generally perpendicular in orientation relative to the retaining strap 20. Particularly, the retaining strap 20 can return to its normal position on the second side of the wall 106 via manual manipulation, for example, by pulling on the proximal end 24 of the retaining strap 20 so that it assumes the configuration shown in FIG. 2c. Alternatively, the retaining strap 20 can be made of a resilient material which has a spring memory so that the retaining strap 20 is effectively biased or stressed when manipulated to assume the insertion position and itself and, in turn, the anchoring member 30 resume their normal unbiased position on the second side of the wall 106. Preferably, the retaining strap 20 has a width which is slightly less than the width of the hole 102 in order to center the strap in the hole.

As shown in FIG. 2c, once the anchoring member 30 and retaining strap 20 return to their normal positions (where the anchoring member 30 is located generally perpendicular to the retaining strap 20), the user pulls on the proximal end 24 of the retaining strap 20, on the first side of the wall 104, so that the anchoring member 30 is positioned in its final intended position flush against the second side of the wall 106, on either side of the hole 102.

The anchoring member 30 serves to support the object to be retained on the wall 100 by spreading the load and weight of the object across the length of the portion of the anchoring member 30 which contacts or abuts the second side of the wall 106. The heavier the object is to be retained, the longer the anchoring member can be in order to spread the force over a greater surface area on the second side of the wall 106.

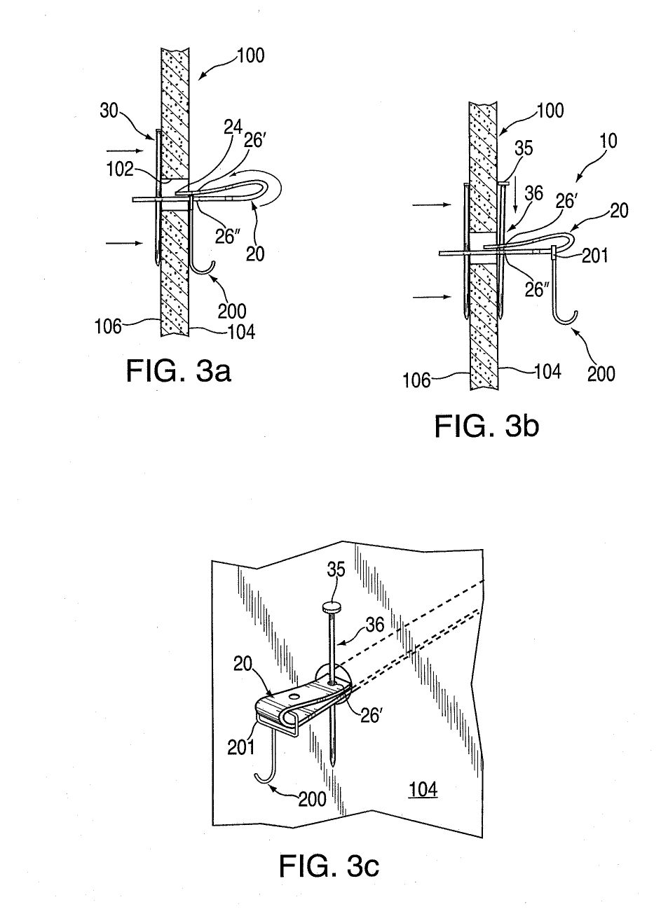

The object to be retained can then be fastened by locking means which are located at least partially on the first side of the wall 104 and which are fastened to the retaining strap 20. As shown in FIG. 2d, once the anchoring member 30 has been positioned as shown in FIG. 2c, the object 200 to be mounted to the wall, in this case a J-shaped hook 200 having a rectangular eyelet 201 (FIG. 3c), is placed over the proximal end 24 of the retaining strap 20 on the first side of the wall 104. The hook 200 is then pushed towards the wall 100 until it is positioned adjacent the wall (FIG. 2d).

As shown in FIG. 2e, a first embodiment of the locking means for fastening object 200 to the wall 100 comprising a second, rigid anchoring member 36, preferably a nail, is inserted into the hole 26 adjacent to the first side of the wall 104, so that the second, rigid anchoring member spans the diameter of the hole 102 and is parallel to the anchoring member 30 on the second side of the wall 106. In effect, the second anchoring member 36 serves as a “front” anchoring member and forms a mirror image with the first anchoring member 30 which, in effect, serves as a “back” anchoring member. The second anchoring member 36 serves to lock the retaining strap 20 and the first anchoring member 30 and, in turn, the object 200 to the wall 100. The second anchoring member 36 must be inserted into a hole 26 in the retaining strap 20 so that there is a tight fit of the fastening assembly 10 with the wall 100.

The head 35 of the nail 36 preferably has a diameter which is dimensioned larger than the body or shank 37 of the nail 36, to accommodate any space between the anchoring member 36 and the wall 100 in order to provide a tight fit. Optionally, the retaining strap 20 can then be cut to a desired length.

Various other embodiments of locking means to fasten the object to the retaining strap 20 and, thus the assembly 10 to the wall 100 are illustrated in FIGS. 3a-7 and are discussed in greater detail below.

Particularly, a second embodiment of locking means to fasten an object to the wall 100 is shown in FIGS. 3a-3c. In this embodiment, the J-shaped hook 200 having a rectangular eyelet 201 is slid onto the retaining strap 20, as shown in FIG. 2d and is placed in a desired position on the retaining strap 20. Optionally, the user can then cut the retaining strap 20 to a desired length. As shown in FIG. 3a, the user then forms a loop with the retaining strap 20 by bending the proximal end 24 of the retaining strap 20 over itself towards the first side of the wall 104 until two of the holes 26′, 26″ of the retaining strap, are aligned generally adjacent to the first side of the wall 104. As shown in FIG. 3b, the second, rigid anchoring member 36 is inserted into the aligned holes 26′, 26″ adjacent to the first side of the wall 104. The second anchoring member 36 again, in effect forms a “front” anchoring member which cooperate with the “rear” anchoring member 30 to lock the retaining strap 20 and, in turn, the object 200 to the wall 100. The second anchoring member 36 must also be inserted into the aligned holes 26′, 26″ in the retaining strap 20 closely adjacent the first side of the wall 106, so that there is a tight fit with the wall 100.

As seen in FIG. 3a, the object 200 can be positioned adjacent to the first side of the wall 104 and held in place in its final position between the wall 100 and the second anchoring member 36 (not shown). Alternatively, as shown in FIGS. 3b and 3c, the object 200 can be placed on the portion of the retaining strap 20 which forms the loop and in its final position, the second anchoring member 36 is positioned between the object 200 and the wall 100, so that the object 200 remains on the looped portion of the retaining strap 20. It is also possible to place an object onto the loop after it is formed such as by hooking or tying around the loop.

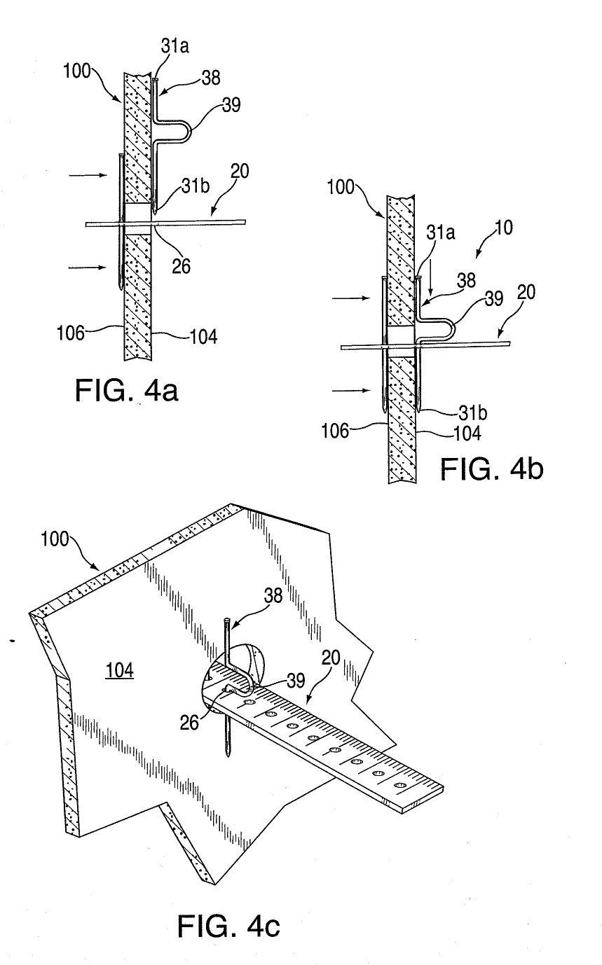

Another embodiment of locking means is shown in FIGS. 4a through 4c. In this embodiment, the locking means is a bent, rigid anchoring member 38 preferably in the form of a nail which has two ends 31a and 31b and a U-shaped bend 39 formed in between. After the anchoring member 30 and retaining strap 20 have been positioned as shown in FIG. 2c, the bent anchoring member 38 is inserted into the hole 26 adjacent to the first side of the wall 104, so that it spans the diameter of the hole 102 and is parallel to the anchoring member 30 on the second side of the wall 106. Here too, the second anchoring member 38 cooperates with the first anchoring member 30 and serves to lock the retaining strap 20 and, in turn, assembly 10 and, in turn, the object to be retained (not shown) to the wall 100. The object to be retained (not shown) can then be secured to the anchoring member 38, such as, for example, by being hooked on or tied around the U-shaped bend 39.

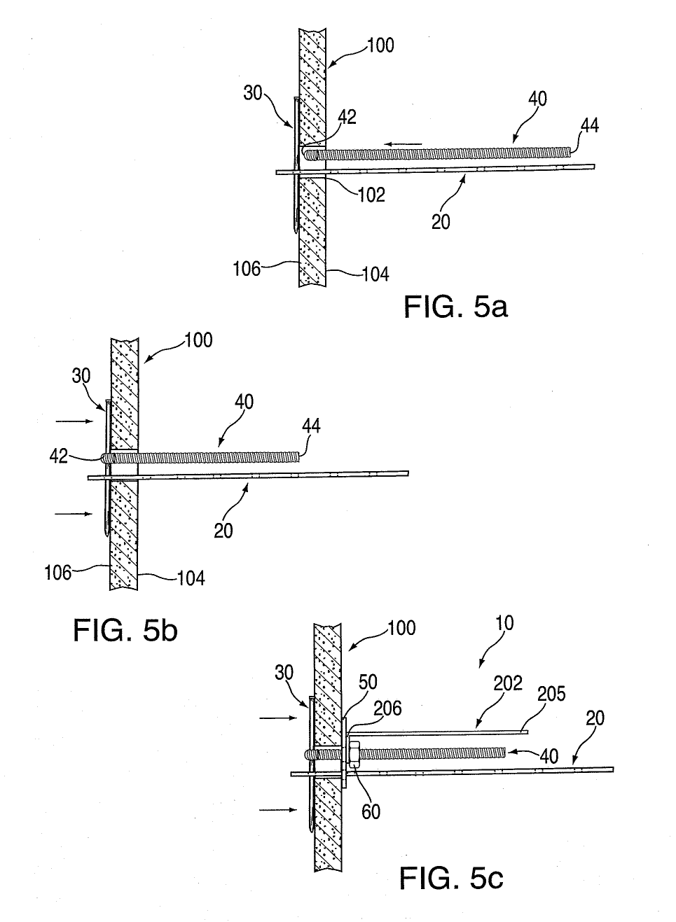

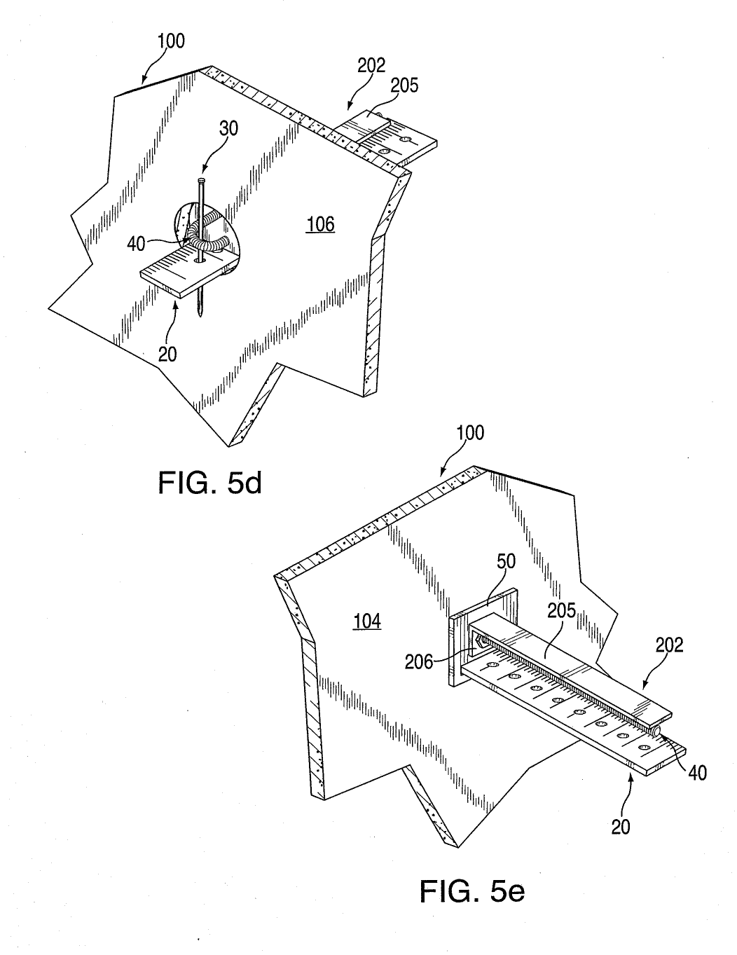

In yet another embodiment of the locking means is shown in FIGS. 5a-5e. In this embodiment, the locking means comprises an externally threaded rod 40 having a hook-shaped or J-shaped distal end 42 and a proximal end 44 opposite therefrom. As best seen in FIG. 5a, the hook-shaped distal end 42 of the externally threaded rod 40 is configured and dimensioned to permit it to be inserted into and through the hole 102 in the wall 100, from the first side of the wall 104 to the second side of the wall 106. The hook-shaped distal end 42 is also configured and dimensioned to hook around the anchoring member 30 on the second side of the wall 106, as shown in FIG. 5b. The externally threaded rod 40 has a length which is greater than the thickness or depth of the wall 100 so that the proximal end 44 of the rod 40 remains on the first side of the wall 104 when the distal end 42 is hooked around the anchoring member 30. The locking means also comprises an internally threaded nut 60 which is configured and dimensioned to be screwed onto the externally threaded rod 40 (FIG. 5c).

In order to lock the assembly 10 and the object to the wall once the anchoring member 30 and the retaining strap 20 have been positioned as shown in FIG. 5a, the hook-shaped distal end 42 of the externally threaded rod 40 is inserted into the hole 102 in the wall 100, from the first side of the wall 104 to the second side of the wall 106 (see arrow), while the proximal end 44 remains on the first side of the wall 104. As shown in FIGS. 5b and 5d, the proximal end 44 is then manually manipulated so that the opposite hook-shaped distal end 42 is hooked around the anchoring member 30, on the second side of the wall 106. Optionally, a washer 50 can be placed over the retaining strap 20 and externally threaded rod 40 on the first side of the wall 104, in case the object to be retained is smaller than the diameter of the hole 102 in the wall 100, to prevent the object from passing through the hole 102.

As shown in FIGS. 5c-5e, the object 202 to be mounted or secured to the wall, in this case an L-shaped shelf or bracket, having a relative long, horizontal disposed, flat upper arm 205 and a vertically disposed lower arm 206 with a hole (not shown) formed therein is placed over the externally threaded rod 40 so that it is positioned adjacent to the wall 100. An internally threaded nut 60 is then screwed onto the rod 40 and is tightened to hold the object 202 to assembly 10 and, in turn, to the wall 100. Optionally, the retaining strap 20 can then be cut to a desired length to remove an excess portion on the first side of the wall.

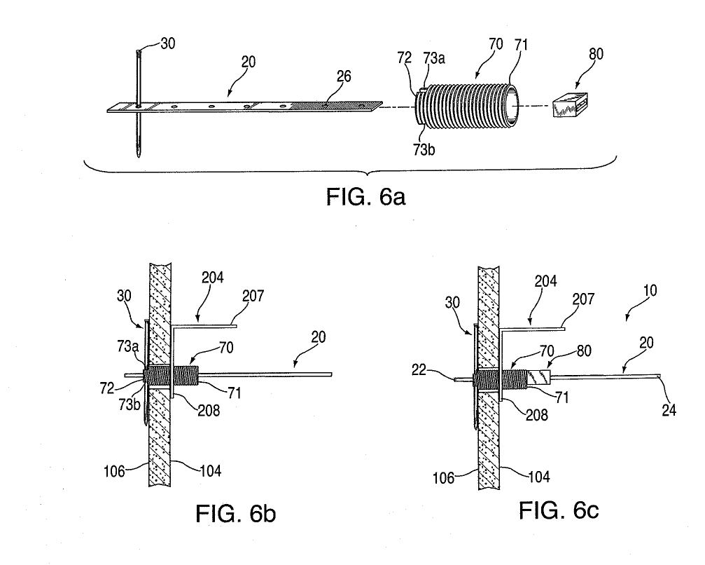

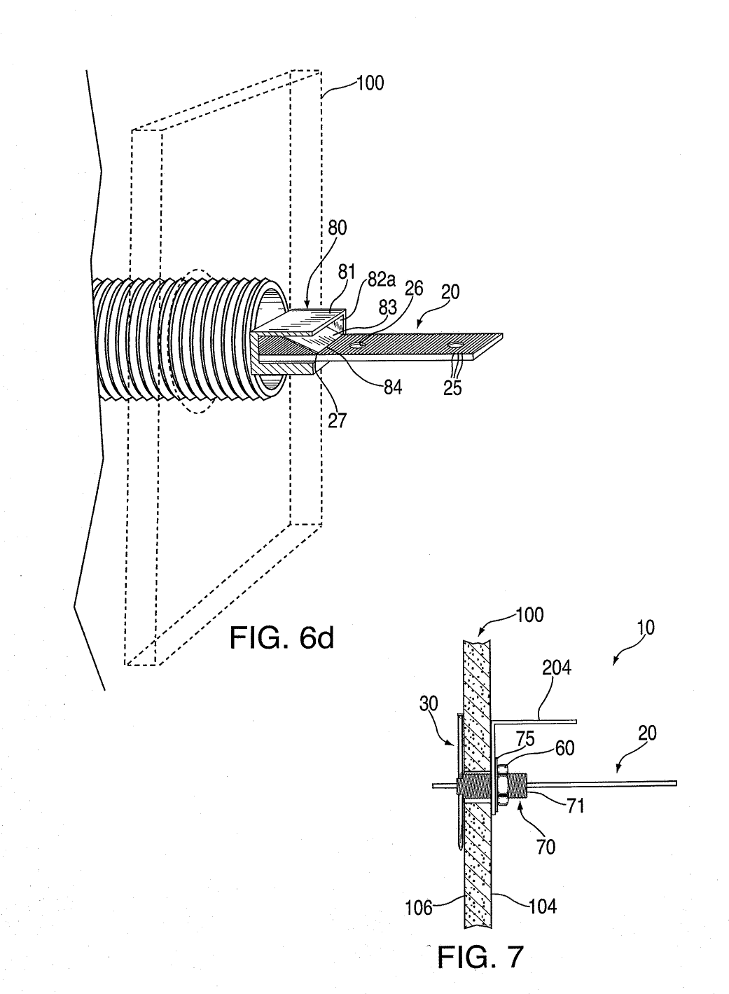

Yet another embodiment of locking means is shown in FIG. 6a through FIG. 6d. As seen best FIG. 6d, the upper face of retaining strap 20 has a multiple of serially-arranged ridge 25 formed in it. Also provided is a slidable locking member 80 which is configured and dimensioned to permit it to be slidably received over the proximal end 24 of the retaining strap 20 and which can be advanced towards the distal end 22, but which has means to lock onto the ridges 25 of the retaining strap 20 to prevent the locking member 80 from sliding towards the proximal end 24 of the retaining strap 20. Particularly, as seen in FIG. 6d, the locking member 80 has an external housing 81 having two opposite open ends 82a and 82b (not shown) which allow it to be slidably received over the retaining strap 20. The locking member 80 also has a downwardly sloped angled wall 83 having an end 84 which is configured and dimensioned to act like a sliding pawl which engages and is received within the spaces 27 formed between adjacent ridges 25 and which, in effect, serve as a one-way ratchet.

Also as seen in FIG. 6a, the locking means comprises a hollow externally threaded cylindrical retaining member 70. The cylindrical retaining member 70 has a proximal end 71 and a distal end 72 which are opposite from each other. The cylindrical retaining member 70 has an external diameter which is the same size as the diameter of the hole 102 and an internal diameter which is large enough to permit the retaining strap 20 to extend inside it. Preferably, the retaining strap 20 has a width which is slightly less than the internal diameter of the cylindrical retaining member 70 so that it fits inside and is prevented from moving around inside the cylindrical retaining member 70. The cylindrical retaining member 70 also has a length which is greater than the thickness of the wall 100 so that it extends from the first side of the wall 104, through the hole 102 in the wall to the second side of the wall 106. On the distal end 72 there are two opposite cut-out or notched portions 73a and 73b. As shown in FIG. 6a, the cut-out portions or notches 73a and 73b are configured and dimensioned to receive and seat therein the anchoring member 30 to prevent the cylindrical retaining member 70 from rotating in the hole 102 in the wall (FIG. 6b).

As shown in FIG. 6b, after the anchoring member 30 and the retaining strap 20 are positioned in the manner shown in FIG. 2c, the distal end 72 of the cylindrical retaining member 70 is inserted into the hole 102 from the first side of the wall 104 to the second side of the wall 106. The cut-out portions 73a and 73b on the cylindrical retaining member 70 are aligned with the anchoring member 30 on the second side of the wall 106, so that the anchoring member 30 is received within the cut-out or notched portions 73a and 73b. As shown in FIG. 6b, the object 204 to be retained in this case an L-shaped shelf or bracket having a flat upper arm 207 and a lower vertically disposed lower arm 208 having a hole (not shown) formed therein is then mounted over the externally threaded cylindrical retaining member 70 and is placed adjacent to the wall 100.

Turning to FIG. 6c, the slidable locking member 80 is slid over the proximal end 24 of retaining strap 20 until it reaches and abuts the end of the cylindrical retaining member 70 and locks the entire assembly 10 in place on the wall 100. As seen best in FIG. 6d, the locking member 80 has a width which is greater than the internal diameter of the cylindrical retaining member 70 to prevent it from entering inside the cylindrical retaining member 70.

In a further embodiment of the invention as shown in FIG. 7, instead of using the locking member 80 to lock the assembly to the wall 100, an internally threaded nut 60 is screwed over the cylindrical retaining member 70. The internally threaded nut 60 is configured and dimensioned to be screwed onto the proximal end 71 of the externally threaded cylindrical retaining member 70. A washer 75 can optionally be employed with the nut 60, as shown in FIG. 7.

There have been described and illustrated herein exemplary methods, steps and assemblies embodying the present invention for fastening an object to a wall which accommodate a variety of applications. For example the wall fastening assembly can be utilized on a series of walls. For example, the anchoring member and the retaining strap can be passed through a series of spaced apart walls and the anchoring member can lie against the rearward most wall. Alternatively, more than one anchoring member can be retained in the retaining strap and each anchoring member can lie against the second side of a different wall. To aid in placing the retaining strap and anchoring member through the series of walls, a hollow tube can be placed within the aligned holes in the various walls and the retaining strap and anchoring member can then be passed through the inside of the hollow tube to prevent it from falling between the walls.

It will therefore be appreciated by those skilled in the art that yet other modifications could be made to the provided invention without deviating from its spirit and scope as claimed.

What is claimed is:

1. A fastening assembly for retaining an object to a wall having a first and second side, and a hole extending therethrough, comprising:
an elongated, flexible planar retaining strap having a distal end configured and dimensioned for insertion into and through the hole in the wall, a proximal end opposite therefrom, and a length which is greater than the thickness of the wall;
a first elongated, rigid anchoring member having two opposite ends, each of which is configured and dimensioned for insertion into and through the hole in the wall, and having a length which is greater than the diameter of the hole in the wall and which is mounted adjacent said distal end of said retaining strap so it normally assumes a position generally perpendicular to said planar retaining strap, and wherein said anchoring member has a width which permits it to be initially inserted via one of its said ends into and through the hole in the wall from the first side of the wall to the second side of the wall and wherein said flexible retaining strap can be manipulated and bent relative to said anchoring member to permit said distal end of said retaining strap and said anchoring member to be inserted from the first side of the wall through the hole in the wall, to the second side of the wall and wherein when said anchoring member, upon being fully inserted through the hole in the wall, assumes its normal generally perpendicular orientation relative to said retaining strap on the second side of the wall; and
means for locking said retaining strap and, in turn, said assembly to the wall, which is located on the first side of the wall so that the object to be retained is fastened to the wall.

2. The fastening assembly according to claim 1, wherein:
said retaining strap has at least one hole formed therethrough and said anchoring member is retained in said at least one hole.

3. The fastening assembly according to claim 2, wherein:
said retaining strap has a plurality of spaced apart holes formed therethrough.

4. The fastening assembly according to claim 1, wherein:
said retaining strap has graduations imprinted thereon.

5. The fastening assembly according to claim 1, wherein:
said retaining strap has a plurality of ratchet-like ridges formed therein.

6. The fastening assembly according to claim 1, wherein:
said anchoring member is a nail.

7. The fastening assembly according to claim 1, wherein:
said retaining strap is made of a resilient material which has a spring memory such that said retaining strap is effectively biased to assume said insertion position but resumes said normal unbiased position when said anchoring member is on the second side of the wall.

8. The fastening assembly according to claim 1, wherein:
said anchoring member is retained in said at least one hole of said retaining strap by a friction fit.

9. The fastening assembly according to claim 1, wherein:
said anchoring member has a width which is smaller than the diameter of the hole in the wall.

10. The fastening assembly according to claim 5, wherein:
said means for locking said retaining strap comprises a one-way slidable locking member which is configured and dimensioned to permit it to be slidably received over said proximal end of said retaining strap and advanced towards the distal end of said retaining strap and which has a pawl to lock onto said ridges of said retaining strap to prevent said locking member from sliding towards said proximal end of said retaining strap.

11. The fastening assembly according to claim 1, wherein:
said means for locking said retaining strap comprises an externally threaded rod having a hook-shaped distal end which is configured and dimensioned to permit it to be inserted into and through the hole in the wall from the first side to the second side of the wall and hook around said anchoring member on the second side of the wall, and a proximal end opposite therefrom; and
an internally threaded nut configured and dimensioned to be screwed onto said proximal end of said externally threaded rod.

12. The fastening assembly according to claim 3, wherein:
said means for locking said retaining strap comprises a second elongated rigid anchoring member which has a length which is greater than the diameter of the hole in the wall and is configured and dimensioned to be retained in a hole of said retaining strap on the first side of the wall by a friction fit.

13. The fastening assembly according to claim 12, wherein:
said second anchoring member has two opposite ends and a bend formed between said ends.

14. The fastening assembly according to claim 1, wherein:
said means for locking said retaining strap comprises a hollow, externally threaded cylindrical retaining member having a proximal end and a distal end and two opposite cut out portions on said distal end, which are configured and dimensioned to receive said anchoring member therein; and
an internally threaded nut which is configured and dimensioned to be screwed onto said externally threaded cylindrical retaining member.

15. The fastening assembly according to claim 1, wherein:
said retaining strap has a width which is slightly less than the diameter of the hole in the wall.

16. A method of fastening an object to a wall having a first and second side and a hole extending therethrough, comprising the steps of:
a) providing a wall fastening assembly comprising an elongated, flexible planar retaining strap having a distal end configured and dimensioned for insertion into and through the hole in the wall, a proximal end opposite therefrom, and a length which is greater than the thickness of the wall; a first elongated, rigid anchoring member having two opposite ends, each of which is configured and dimensioned for insertion into and through the hole in the wall, and having a length which is greater than the diameter of the hole in the wall and which is mounted adjacent said distal end of said retaining strap so it normally assumes a position generally perpendicular to said planar retaining strap, and wherein said anchoring member has a width which permits it to be initially inserted via one of its said ends into and through the hole in the wall from the first side of the wall to the second side of the wall and wherein said flexible retaining strap can be manipulated and bent relative to said anchoring member to permit said distal end of said retaining strap and said anchoring member to be inserted from the first side of the wall through the hole in the wall, to the second side of the wall and wherein when said anchoring member, upon being fully inserted through the hole in the wall, assumes its normal generally perpendicular orientation relative to said retaining strap on the second side of the wall; and means for locking said retaining strap and, in turn, said assembly to the wall, which is located on the first side of the wall so that the object to be retained is fastened to the wall;
b) bending said retaining strap from said normal position to said insertion position;
c) inserting said distal end of said retaining strap and said anchoring member from the first side of the wall through the hole in the wall to the second side of the wall, so that said anchoring member is fully inserted through the hole in the wall to permit said assembly to return to its normal position on the second side of the wall, while holding said proximal end of said retaining strap;
d) pulling said proximal end of said retaining strap so that said anchoring member is positioned against the second side of the wall; and
e) fastening the object to be retained onto said retaining strap by the means for locking.

17. The method according to claim 16, wherein step e) comprises the steps of:
placing the object to be retained over said proximal end of said retaining strap;
providing a second anchoring member which has a length which is greater than the diameter of the hole in the wall and is configured and dimensioned to te retained in a hole of said retaining strap on the first side of the wall by a friction fit;
inserting said second anchoring member into said aligned holes adjacent to the wall.

18. The method according to claim 16, wherein step e) comprises the steps of:
placing the object to be retained over said proximal end of said retaining strap;
forming a loop in said retaining strap by bending said proximal end of said retaining strap over itself towards the wall;
aligning two of said plurality of holes on said retaining strap adjacent to the opening in the wall;
providing a second anchoring member which has a length which is greater than the diameter of the hole in the wall and is configured and dimensioned to be retained in a hole of said retaining strap on the first side of the wall by a friction fit;
inserting said second anchoring member into said aligned holes adjacent to the wall.

19. The method according to claim 16, wherein step e) comprises the steps of:
forming a loop in said retaining strap by bending said proximal end of said retaining strap over itself towards the wall;
aligning two of said plurality of holes on said retaining strap adjacent to the opening in the wall;
providing a second anchoring member which has a length which is greater than the diameter of the hole in the wall and is configured and dimensioned to be retained in a hole of said retaining strap on the first side of the wall by a friction fit;
inserting said second anchoring member into said aligned holes adjacent to the wall; and
fastening the object to be retained onto said loop.

20. The method according to claim 16, wherein step e) comprises the steps of:
providing a second elongated rigid anchoring member which has a length which is greater than the diameter of the hole in the wall and is configured and dimensioned to be retained in a hole of said retaining strap on the first side of the wall by a friction fit and having two opposite ends and a bend formed between said ends.
inserting said second anchoring member into one of said plurality of holes of said retaining strap adjacent to the opening in the wall; and
fastening the object to be retained onto said bend of said second anchoring member.

21. The method according to claim 16, wherein step e) comprises the steps of:
providing an externally threaded rod having a hook-shaped distal end which is configured and dimensioned to permit it to be inserted into and through the hole in the wall from the first side to the second side of the wall and hook around said anchoring member and a proximal end opposite therefrom and an internally threaded nut configured and dimensioned to be screwed onto said proximal end of said externally threaded rod;
inserting said hook-shaped distal end of said externally threaded rod from the first side of the wall through the hole in the wall and to the second side of the wall;
hooking said hook-shaped distal end of said externally threaded rod around said anchoring member on the second side of the wall;
placing the object to be retained over said proximal end of said externally threaded rod; and
screwing said internally threaded nut over said proximal end of said externally threaded rod.

22. The method according to claim 16, wherein step e) comprises the steps of:
providing a hollow, externally threaded cylindrical retaining member having a proximal end and a distal end and two opposite cut out portions on said distal end, which are configured and dimensioned to receive said anchoring member therein and an internally threaded nut which is configured and dimensioned to be screwed into said proximal end of said externally threaded cylindrical retaining member;
inserting said distal end of said externally threaded cylindrical retaining member from the first side of the wall through the hole in the wall and to the second side of the wall;
aligning the cut out portions on said distal end of said externally threaded cylindrical retaining member with said anchoring member on the second side of the wall such that said retaining member is received within said cut out portions of said cylindrical retaining member;
placing the object to be retained over said proximal end of said externally threaded cylindrical retaining member;
screwing said internally threaded nut over said externally threaded cylindrical retaining member.

23. The method according to claim 16 wherein:
in said step a) said elongated, flexible planar retaining strap has a plurality of ratchet-like ridges formed therein and in said step e) said locking means is a one-way slidable locking member which is configured and dimensioned to permit it to be slidably received over said proximal end of said retaining strap and advanced towards the distal end of said retaining strap and which has a pawl to lock onto said ridges of said retaining strap to prevent said locking member from sliding towards said proximal end of said retaining strap and, in turn, locks said assembly to the wall on the first side of the wall so that the object to be retained is fastened to the wall and a hollow, externally threaded cylindrical retaining member having a proximal end and a distal end and two opposite cut out portions on said distal end, which are configured and dimensioned to receive said anchoring member therein; and wherein step e) comprises the steps of:
inserting said distal end of said externally threaded cylindrical retaining member from the first side of the wall through the hole in the wall and to the second side of the wall;
aligning the cut out portions on said distal end of said externally threaded cylindrical retaining member with said anchoring member on the second side of the wall such that said retaining member is received within said cut out portions of said cylindrical retaining member;
placing the object to be retained over said proximal end of said externally threaded cylindrical retaining member; and
sliding said locking member over said proximal end of said retaining strap so that said pawl locks onto said ridges of said retaining strap adjacent to the proximal end of said cylindrical retaining member.
